(19) United States
(12) Patent Application Publication
(10) Pub. No.: US 2010/0102465 A1
(43) Pub. Date: Apr. 29, 2010

(54) PLASTIC LENS MOLDING METHOD

(75) Inventor: Noriko Eiha, Kanagawa (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/531,380

(22) PCT Filed: Mar. 18, 2008
(86) PCT No.: PCT/JP2008/055623

§ 371 Date: Sep. 15, 2009

(30) Foreign Application Priority Data
Mar. 20, 2007 (JP) 2007-072253

(51) Int. Cl. B29D 11/00

(52) U.S. Cl. 264/2.7

(57) ABSTRACT

A plastic lens molding method includes: preparing a lens preform having the temperature equal to or higher than a glass transition point temperature; and molding a lens by compressing the lens preform having the temperature equal to or higher than the glass transition point temperature, the compressing of the lens preform being performed by a mold providing a finished lens dimension at a constant temperature equal to or lower than the glass transition point temperature.

### TECHNICAL FIELD

The present invention relates to a plastic lens molding method, and more particularly to a plastic lens molding method in which a lens preform prepared by injection molding is compression-molded to mold a plastic lens.

### BACKGROUND ART

Heretofore, as a plastic lens molding method, from a viewpoint of productivity, a molding method of supplying melting resin from a gate into a cavity formed by a fixed side mold and a movable side mold has been abundantly used. According to this molding method, in order to compensate mold shrinkage caused by cooling of the melding resin in the cavity, the melding resin, while being supplied from the gate upon reception of pressure, is cooled. In result, the residual stress is produced near the gate and optical strain remains, which becomes a factor of lowering optical performance of a lens.

As a method of avoiding occurrence of such the residual stress to mold a plastic lens having high accuracy and a low birefringence, there has been known a method of molding a lens preform having the nearly same configuration as the configuration of a lens product by injection molding, and thereafter filling the lens preform in an aging mold for compression molding (refer to, for example, JP-A-4-163119 (the term “JP-A” as used herein means an “unexamined published Japanese patent application”)).

Further, there has been known a method of molding a lens preform in which a lens preform obtained by injection molding is carried into a stress relaxation room which has been decompressed and kept at a predetermined temperature for at least three hours, thereby to remove residual stress (refer to, for example, JP-A-8-336833).

According to a method of manufacturing a plastic molded item disclosed in JP-A-4-163119, a molded item obtained by injection molding is filled into an aging mold of which the temperature is equal to or lower than a thermal deformation temperature, the aging mold is heated to a temperature equal to or higher than a glass transition point temperature and maintained for a predetermined time. Thereafter, the aging mold is gradually cooled to form the molded item into a plastic molded item. Therefore, since the aging mold must be heated to the temperature equal to or higher than the glass transition point temperature and further cooled, a molding cycle prolongs, so that there is a problem that productivity is bad.

Further, according to a molding method of a lens blank disclosed in JP-A-8-336833, a lens blank (lens preform) obtained by injection molding is held for at least three hours in a stress relaxation room which has been decompressed to 76 cmHg and maintained at a constant temperature of 80° C., thereby to relax stress. Therefore, it takes a long time to mold the lens blank, so that there is a problem that productivity lowers.

### DISCLOSURE OF THE INVENTION

The invention has been made in view of the above circumstances, and its object is to provide a plastic lens molding method in which there is little optical strain caused by residual stress in the injection molding time and a lens having excellent optical characteristics can be efficiently molded in a short molding cycle time.

The above object of the invention is achieved by the following plastic lens molding method.

(1) According to an aspect of the present invention, a plastic lens molding method including: preparing a lens preform having the temperature equal to or higher than a glass transition point temperature; and molding a lens by compressing the lens preform having the temperature equal to or higher than the glass transition point temperature, the compressing of the lens preform being performed by a mold providing a finished lens dimension at a constant temperature equal to or lower than the glass transition point temperature.

According to the above plastic lens molding method, since the lens preform having the temperature equal to or higher than the glass transition point temperature is compressed by the mold having the constant temperature which is equal to or lower than the glass transition point temperature thereby to provide the finished lens dimension, a reheating step of heating again the lens preform to the temperature equal to or higher than the glass transition point temperature is not required. In result, the molding time of the plastic lens can be reduced. Hereby, the plastic lens can be molded with good production efficiency. Further, in the initial stage of compression, since the temperature of the lens preform is equal to or higher than the glass transition point temperature, it is possible to mold a plastic lens having no optical strain and having excellent optical characteristics.

(2) The plastic lens molding method as described in the item (1), wherein the preparing of the lens preform prepares a lens preform having the same weight as the weight of the lens.

According to the above plastic lens molding method, since the lens preform having the same weight as the weight of the lens in the finished dimension is prepared in the preparing step, the finished lens dimension can be provided surely in the compression-molding step. Hereby, it is possible to mold a plastic lens having excellent optical characteristics. Further, in case that accuracy in weight is thus good, accuracy in not only the shape of an optical surface but also in configuration such as an outer diameter or a thickness of the lens becomes high, so that optical performance of a lens unit formed by combination of plural lenses can be made high in entirety.

(3) The plastic lens molding method as described in the item (2), wherein the molding of the lens comprises performing an injection molding of the lens preform.

According to the above plastic lens molding method, since the lens preform is molded by injection molding, it is possible to mold a lens preform having the same weight and the nearly same configuration as the desired lens. Further, since the lens preform is compression-molded to obtain a plastic lens in the finished dimension, a gate vestige and optical strain remaining in the lens preform can be almost eliminated, so that a plastic lens having excellent optical characteristics can be molded.

(4) The plastic lens molding method as described in the item (3), wherein the molding of the lens includes: taking out the lens preform from an injection-molding machine at the temperature equal to or higher than the glass transition point temperature; and immediately putting the lens preform, which is taken out from the injection-molding machine, in a compression mold.

According to the above plastic lens molding method, by shortening the time for shift from the injection molding of the lens preform that is the preparing step to the compression molding thereof, it is possible to prevent the temperature of the lens preform from lowering, and not only reduction of the shift time but also time reduction in the compression molding step can be carried out.

(5) The plastic lens molding method as described in the item (2), wherein the preparing of the lens preform includes: extruding a constant volume of melting plastic; and cutting the extruded melting plastic.

According to the above plastic lens molding method, the desired volume of plastic is cut from the melting plastics in consideration of lens configuration and size after cooling, whereby the lens preform is prepared. Therefore, the lens preform can be prepared by a simple and inexpensive apparatus.

(6) The plastic lens molding method as described in the item (1), wherein the preparing of the lens preform includes punching out the lens preform from a molded item having a sheet-shaped.

According to the above plastic lens molding method, since the lens preform is punched out from the sheet-shaped molded item in the lens shape by the mold used in the compression molding step, gate vestige which cannot be eliminated in the lens preform molded by injection molding can be eliminated, so that a plastic lens having excellent optical characteristics can be readily molded. Further, since the number of lens preforms blanked at one time can be readily increased, mass production of lens preform can be readily met.

According to the invention, it is possible to provide a plastic lens molding method in which there is little optical strain caused by residual stress in the injection molding time and a lens having excellent optical characteristics can be efficiently molded in a short molding cycle time.

### BRIEF DESCRIPTION OF THE DRAWINGS

The invention disclosed herein will be understood better with reference to the following drawings of which:

FIG. 1 is a schematic diagram of a plastic lens molding apparatus to which a plastic lens molding method in an embodiment of the invention is applied;

FIG. 2 is a main portion longitudinal sectional view of a hot runner type lens preform molding mechanism suited to apply the plastic lens molding method of the invention thereto;

FIGS. 3A to 3C are main portion longitudinal sectional views of a compression molding mechanism which compresses, in the finished dimension, the lens preform molded by the lens preform molding mechanism thereby to mold a plastic lens in the finished shape;

FIG. 4 is a schematically sectional view, showing a lens preform molding mechanism in another embodiment which supplies a compression molding preform having a desired volume;

FIG. 5 is a partially enlarged sectional view of the vicinity of a piston and an ejection port; and

FIGS. 6A to 6C are perspective views showing a concrete example of the cutting operation of resin material by a cutter.

### BEST MODE FOR CARRYING OUT THE INVENTION

A plastic lens molding method according to the invention will be described below in detail with reference to drawings. The plastic lens molding method according to the invention includes a preparing step of preparing a lens preform, and a compression-molding step of compressing the lens preform by a mold and providing a finished lens dimension thereby to mold a plastic lens.

The preparing step is a step of preparing a lens preform having a temperature equal to or higher than a glass transition point temperature by a lens preform molding mechanism. The compression molding step is a step of compressing the lens preform having the temperature equal to or higher than the glass transition point temperature by a compression molding mechanism having a temperature equal to or lower than the glass transition point temperature, and providing the finished lens dimension thereby to mold a plastic lens.

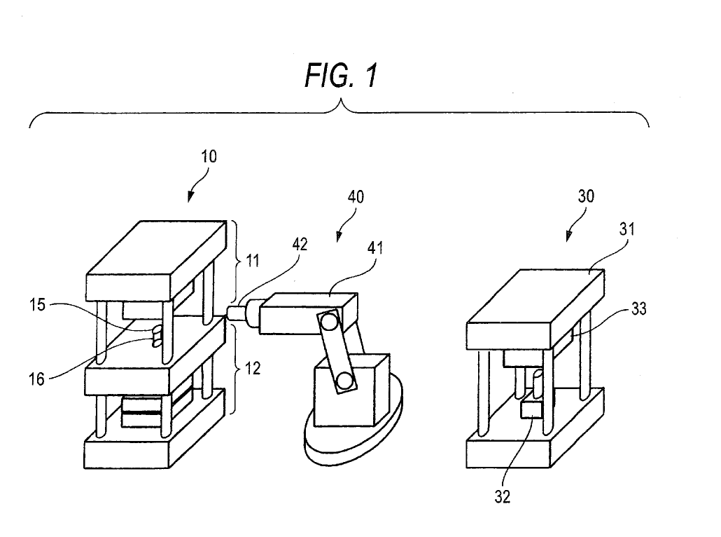

FIG. 1 is a schematic diagram of a plastic lens molding apparatus to which the plastic lens molding method according to an embodiment of the invention is applied.

As shown in FIG. 1, the plastic lens molding apparatus in this embodiment includes a lens preform molding mechanism 10, a handling mechanism 40, and a compression-molding mechanism 30.

The lens preform molding mechanism 10 is basically composed of a fixed side mold 11 and a movable side mold 12. By the fixed side mold 11 which supplies melting resin and the movable side mold 12, a lens preform 15 is molded, and this molded lens preform 15 which has the temperature equal to or higher than the glass transition point temperature is ejected from the movable side mold 12 by an ejector pin 16, spaced apart from the movable side mold 12, and exposed. The detailed description of the lens preform molding mechanism 10 will be described later.

Next, the handling mechanism 40, before the temperature of the molded lens preform 15 which is exposed comes to the temperature which is equal to or lower than the glass transition point temperature, carries and places the lens preform 15 onto the compression-molding mechanism 30 which determines the finished lens shape. In this handling mechanism 40, a handling portion 42 located at a leading end of an arm 41 is subjected to coating of fluorine-based resin or rough surface processing, whereby a contact surface thereof with the soft lens preform 15 is kept in a non-adhesive state, so that the handling mechanism 40 can smoothly perform delivery of the lens preform to the compression-molding mechanism 30.

The compression-molding mechanism 30 is mainly composed of an upper mold 31, a lower mold 32, and a body mold 33. The lens preform 15 carried by the handling mechanism 40 is placed on the lower mold 32, and subjected to compression molding in a cavity 37 of the compression-molding mechanism 30 to be formed in the finished shape of a plastic lens. Thereafter, the lens preform 15 is taken out of the cavity 37 while being held by the lower die 32.

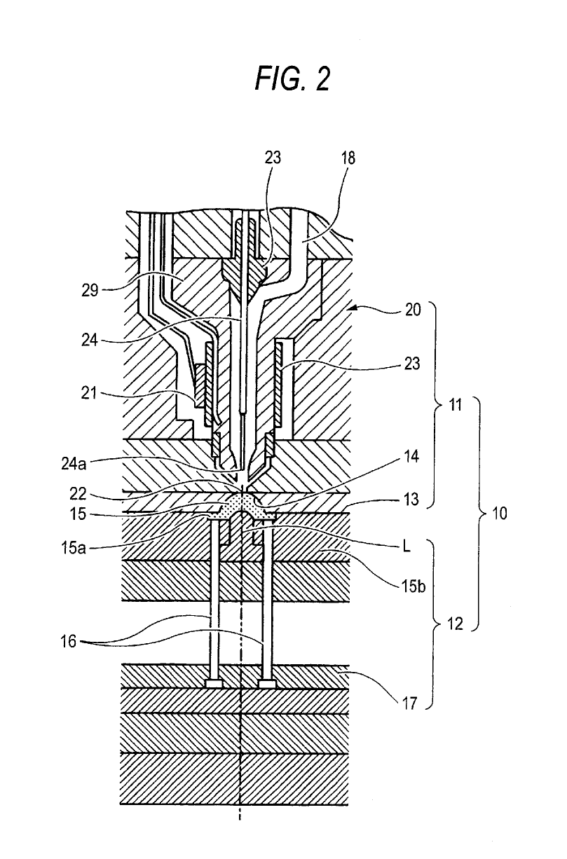

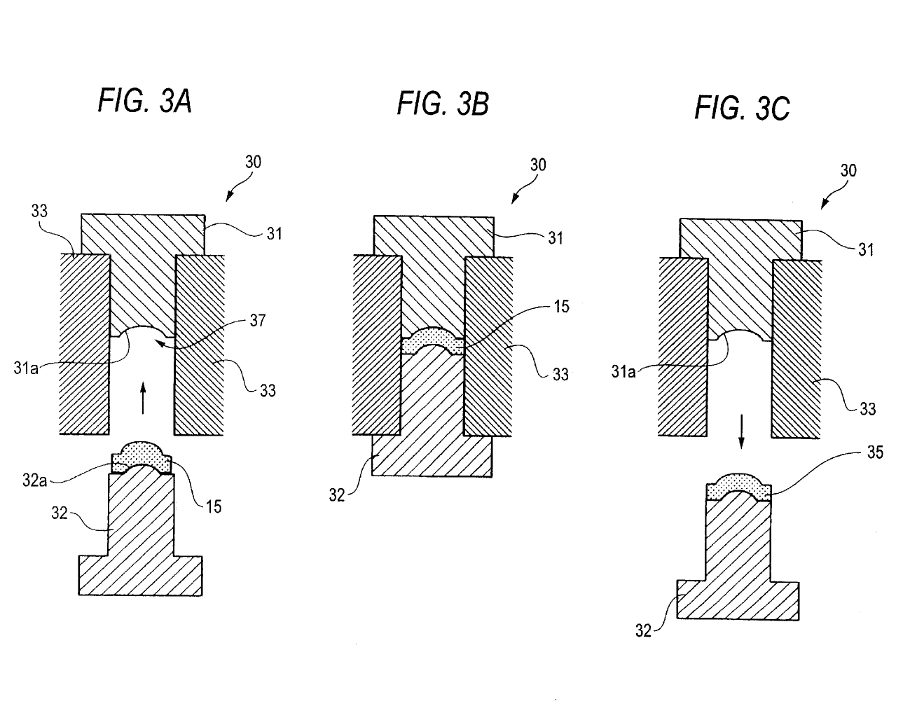

FIG. 2 is a main portion longitudinal sectional view of a hot runner type lens preform molding mechanism (injection molding mechanism) suitable to apply the plastic lens molding method of the invention thereto, and FIG. 3 is a main portion longitudinal sectional view of the compression molding mechanism which compresses the lens preform molded by the lens preform molding mechanism thereby to mold a plastic lens in the finished shape.

As shown in FIG. 2, the lens preform molding mechanism 10 in the embodiment includes the fixed side mold 11, the movable side mold 12, a hot runner 20 which supplies molting resin in a cavity 14 formed by a stationary retainer plate 13 of the fixed side mold 11 and a movable retainer plate 15b of the movable side mold 12, and the ejector pin 16 which penetrates the movable retainer plate 15b forming a flange portion 15a of the lens preform 15, ejects the flange portion 15a from the movable side mold 12 and spaces the flange portion 15a apart from the movable side mold 12.

The fixed side mold 11 and the movable side mold 12 are attached respectively to a fixed side and a movable side of a not-shown injection molding apparatus. The movable side mold 12 is arranged contactably and separably (movably in the axial direction) in relation to the fixed side mold 11.

When the fixed side mold 11 and the movable side mold 12 are clamped, the cavity 14 for forming the lens preform 15 is formed inside. The capacity and the shape of the cavity 14, so that resin having the same weight as the weight of a plastic lens 35 which is a finished product is put in the cavity 14, are made respectively the volume considering thermal expansion, and nearly the same shape as the shape of the plastic lens 35. An optical axis L of the lens preform 15 and the mold opening direction are substantially parallel.

For the movable side mold 12, the ejector pin 16 supported by an ejector plate 17 is provided retractably. The ejector pin 16, when the melting resin is filled in the cavity 14 and the fixed side mold 11 and the movable side mold 12 are opened, presses the flange portion 15a of the lens preform 15 thereby to space the lens preform 15 apart from the movable side mold 12.

The hot runner 20 is a so-called external heating type hot runner, which is arranged in the fixed side mold 11. Around a cylinder 29 provided with a path 18 for supplying melting resin, a heater 23 and a temperature sensor 21 are arranged, whereby the temperature of the melding resin is controlled at an optimum temperature to adjust viscosity of the melting resin, and occurrence of burn mark caused by overheating is prevented.

A nozzle (gate) 22 of the hot runner 20 opens on the center portion of the cavity 14 in the fixed side mold 11, that is, on an optical axis L on an optical surface 35a of a lens 35 obtained by compression molding.

The nozzle 22 is opened and closed by a valve pin 24 held slidably by a needle guide 23. Namely, when the melting resin is supplied, the valve pin 24 is raised to open the nozzle 22 as shown in FIG. 2; and in other time than the supplying time, the nozzle 22 is closed to stop the supply of the melding resin. Since the difference in diameter between the hole diameter of the nozzle 22 and the outer diameter of the valve pin 24 is, for example, about 5 to 7 μm, when the nozzle 22 is closed, the melting resin does not leak from the nozzle 22.

A leading end surface 24a of the valve pin 24 when the nozzle 22 is closed is adjusted so as to be located a little inside the leading end of the nozzle 22 (a little above the leading end of the nozzle 22 in FIG. 2). Therefore, when the lens preform 15 is molded, the gate vestige is formed in the slightly protruding shape. This protruded gate vestige can be readily eliminated in the next step, compression molding, though it is difficult to eliminate the concave gate vestige.

Further, the shape of the leading surface 24a of the valve pin 24 is nearly the same as the shape of a portion corresponding to the valve pin leading surface 24a of the plastic lens 35. Accordingly, since the gate vestige of the molded lens preform 15 is formed small, the vestige can be substantially eliminated by the slight compression molding in the next step, and the plastic lens 35 can molded in the finished shape.

The lens preform 15 is molded by supplying and filling the melding resin from the nozzle 22 of the hot runner 20 into the cavity 14, and moving the movable side mold 12 to perform mold opening after the temperature of the cavity surface has come to the temperature equal to or lower than the melting temperature of the resin and to the temperature equal to or higher than the glass transition point temperature. Next, the flange portion 15a of the lens preform 15 is pressed by the ejector pin 16 to space the lens preform 15 apart from the movable side mold 12. At this time, the lens preform 15 is held at the flange portion 15a by the not-shown handling mechanism 40, and carried and supplied to the compression molding machine 30 in the next step while keeping the temperature equal to or higher than the glass transition point temperature. Further, the mold surface in the cavity 14 is subjected to non-adhesive coating for the resin, so that the lens preform 15 can be released from the molds without partially adhering to the molds.

Since the supply of the melting resin to the cavity 14 is performed from the center portion of the cavity 14 of the fixed side mold 11, that is, from the optical axis L of the lens preform 15 to be molded, the flow of the melting resin becomes concentric with respect to the optical axis L. Hereby, the optical strain occurring in the gate portion is formed symmetrically about the optical axis L.

The lens preform 15 thus molded by the lens preform molding mechanism 10, when the temperature of the melting resin filled in the cavity 14 comes to the temperature equal to or higher than the glass transition point temperature, is held at the flange portion 15a by the handling mechanism 40 of which the temperature becomes similarly the temperature equal to or higher than the glass transition point temperature, and taken out from the lens preform molding mechanism 10. The temperature at which the lens preform 15 is taken out in this injection molding step is preferably within a range of Tg+30° C.˜Tg+80° C. (Tg: glass transition point temperature).

While keeping the temperature equal to or higher than the glass transition point temperature, the lens preform 15 is put in a cavity 37 of the compression molding mechanism 30 kept at a contact temperature which is equal to or lower than the glass transition point temperature, and cooled to the temperature equal to or lower than the glass transition point temperature while receiving compression molding, thereby to be compression-molded into a plastic lens 35 in the finished shape.

As shown in FIG. 3A, the compression molding mechanism 30 includes the upper mold 31, the lower mold 32, and the body mold 33, and the cavity 37 for molding a plastic lens 35 is formed by these parts.

The shape of the cavity 37 is the same as the finished shape of the plastic lens 35, and at least forming surfaces 31a, 32a for molding lens optical surfaces 35a, 35b are subjected to mirror plane processing. Accordingly, the lens optical surfaces 35a, 35b of the plastic lens 35 to which the shapes of the forming surfaces 31a, 32a are transferred are very small in surface roughness, and formed into optical surfaces having excellent optical characteristics.

The compression molding mechanism 30 eliminates the gate vestige and stress produced in the lens preform 15 in the injection molding time by the lens preform molding mechanism 10, and is kept at the constant temperature most suitable to cool the lens preform in a short time, which is the temperature equal to or lower than the glass transition point temperature, for example, at the temperature within a range of Tg to Tg−10° C. (Tg: glass transition point temperature).

In the thus constructed compression molding mechanism 30, as shown in FIG. 3A, the lens preform 15 molded by the lens preform molding mechanism 10 is held at its flange portion 15a by the handling mechanism, placed on the lower mold 32, and put in the cavity 37 of the compression molding mechanism 30. Next, as shown in FIG. 3B, pressing of the lens preform 15 in the body mold 33 by the upper mold 31 and the lower mold 32 at a previously set pressure is started in the compression molding step at the temperature equal to or higher than the glass transition point temperature. While the lens preform 15 is gradually cooled, its temperature becomes the temperature equal to or lower than the glass transition point temperature, and a previously set time at which the lens preform 15 is to be molded in the predetermined shape passes. Then, as shown in FIG. 3C, the lens preform 15 is molded in the finished shape of the plastic lens 35, the molds are opened, and the plastic lens 35 is taken out from the cavity 37.

In this compression state, the temperature of the lens preform 15 lowers gradually, the lens preform 15 shrinks with lowering of the lens preform temperature, and compression is executed to its shrinkage. Accordingly, the lens preform 15 is compressed to the shrinkage by the forming surfaces 31a, 32a subjected to mirror plane processing, and the mold shape is transferred well to the lens preform 15, so that lens optical surfaces 35a, 35b having very small surface roughness are formed.

In this embodiment, the reason why the lens preform 15 having the shape very close to the finished shape of the plastic lens 35 is injection-molded, using the hot runner type injection molding apparatus as the lens preform molding mechanism 10 is that the lens preform 15 having the temperature equal to or higher than the glass transition point temperature is obtained by the hot runner type with good efficiency.

Although preform molding by a cold runner type generates much loss of material, there is possibility in use of the cold runner type.

Further, even in case that the shape in the preparing step is different from the finished shape as described above, the shape in the preparing step is adjusted in the compression molding step. However, in case that the shape in the preparing step is closer to the finished shape, the amount of deformation becomes smaller in the compression molding step. Therefore, this case, since a range of molding condition becomes wide, is preferable.

Further, in the compression molding step, the supply of the lens preform 15 having the same weight as the weight of the plastic lens 35 is required. However, in case that the lens preform 15 having the shape close to the finished shape is prepared by injection molding, weight measurement is not specially required. It is because the substantially same lens preform 15 as a lens preform subjected to the weight measurement at high accuracy can be readily supplied.

It is desirable that the handling portion 42 of the handling mechanism 40 which holds the lens preform 15 having the temperature equal to or higher than the glass transition point temperature is subjected to non-adhesive processing in order to prevent the lens preform 15 from adhering thereto. As the non-adhesive processing, there are coating of fluorine-based resin such as Teflon, a method of forming irregularities on a surface of the holding portion thereby to decrease the contact area with the lens preform 15, and the like. It is more effective to form the irregularities on the surface of the holding portion and further to apply coating of the fluorine-based resin thereon.

As described above, both the injection molding step by the lens preform molding mechanism 10 and an initial step (a step of transferring the finished shape of the plastic lens 35) in the compression molding step by the compression molding mechanism 30 are performed in the state where the temperature of the lens preform 15 is equal to or higher than the glass transition point temperature. Therefore, it is not necessary to heat and cool the lens preform together with an aging mold as in the conventional molding method, or to keep the lens preform for a long time in a stress relaxation room which has been decompressed and kept at a predetermined temperature, so that the plastic lens 35 can be efficiently molded in a short molding cycle time.

Thus, since the lens preform 15 put in the cavity 37 of the compression molding mechanism 30 is kept at the temperature equal to or higher than the glass transition point temperature, holding pressure is hardly required in the injection molding time, and the stress near the gate is hardly produced. Further, the convex gate vestige remaining in the lens preform 15 is eliminated by compression molding and also the optical strain near the gate is almost eliminated.

Further, since the lens preform 15 is cooled while being compressed by the forming surfaces 31a, 32a subjected to the mirror plane processing, the lens optical surfaces 35a, 35b having the very small surface roughness are formed.

Further, even in case that the optical strain remains a little, since the melting resin has been radially injected from the optical axis L of the plastic lens 35 (lens preform 15), the occurrence of comatic aberration or astigmatism due to deviation in transfer speed and shrinkage speed of the melting resin is prevented and the plastic lens 35 which is axis-symmetrical about the optical axis L is molded. Hereby, the plastic lens 35 having the excellent optical characteristics is obtained.

According to the above plastic lens molding method, the lens preform 15 having the temperature equal to or higher than the glass transition point temperature is compressed by the compression molding mechanism (mold) 30 having the constant temperature which is equal to or lower than the glass transition point temperature, thereby to provide the finished lens dimension. Therefore, reheating of the lens preform 15 is not required, and the molding time of the plastic lens 35 can be reduced to mold the plastic lens 35 with good efficiency. Further, since the compression molding is performed at the temperature equal to or higher than the glass transition point temperature, it is possible to mold the plastic lens 35 having no optical strain and having the excellent optical characteristics.

Further, since the lens preform 15 having the same weight as the weight of the lens 35 in the finished dimension is prepared in the preparing step, the finished lens dimension can be surely provided in the compression molding step. Hereby, it is possible to mold the plastic lens 35 having the excellent optical characteristics.

Further, since the lens preform 15 is molded by injection molding, the lens preform 15 having the same weight and the nearly same shape as the desired lens 35 can be molded. Further, since the lens preform 15 is compression-molded into the plastic lens 35 in the finished dimension, the gate vestige and optical strain remaining in the lens preform 15 can be almost eliminated, so that it is possible to mold the plastic lens 35 having the excellent optical characteristics.

Although the gate is arranged in the center portion of the optical surface of the lens preform 15 in the lens preform molding mechanism 10 in this embodiment, since the gate vestige and the optical strain are almost eliminated by the pressure applied by the compression molding mechanism 30, the gate position may be any position of the lens. Further, since the shape of the lens preform may not be close to the lens shape, the following embodiment regarding the preform is proposed. Although the example in which the lens preform is prepared by injection molding has been described in the above embodiment, the lens preform may be prepared by another method.

Another embodiment of the lens preform molding mechanism in the preparing step will be described below.

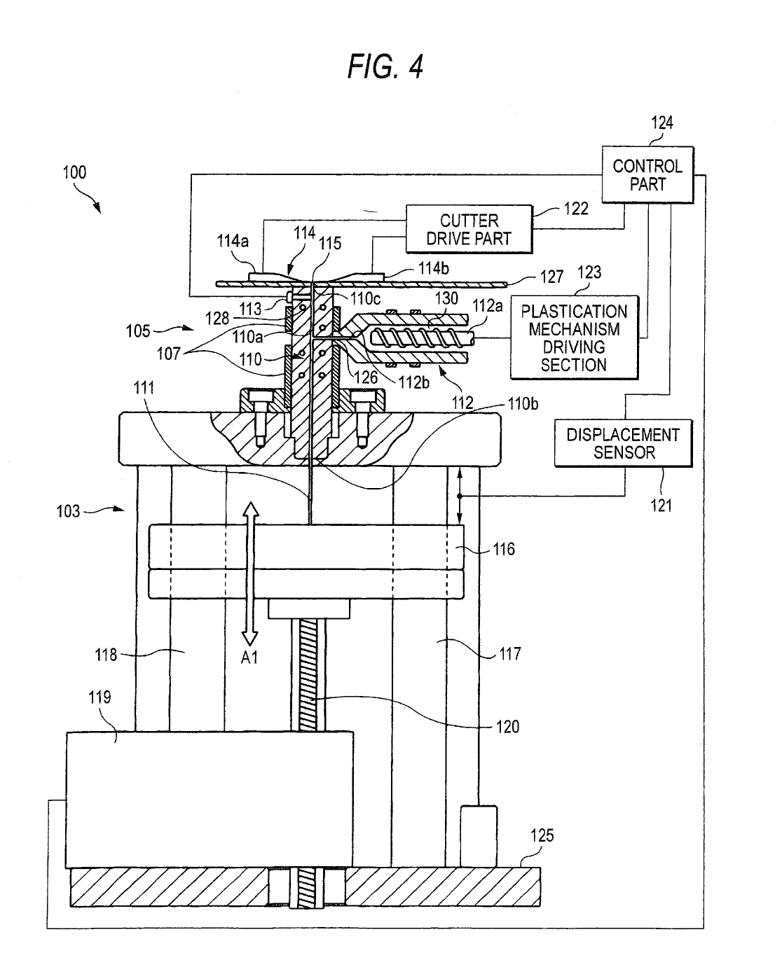

FIG. 4 is a schematically sectional view, showing a lens preform molding mechanism in another embodiment which supplies a compression molding preform having a desired volume.

A compression molding preform manufacturing apparatus 100 which is a lens preform molding mechanism has the constitution common to that of a preplasticating injection molding machine. In this embodiment, particularly, an example of molding a compression molding preform (a fixed amount of a lump of resin) will be described. In the embodiment, it is assumed that a camera plastic lens used in a mobile telephone terminal with a camera is manufactured. The size of this plastic lens is very small, for example, about 2 mm in diameter, and the compression molding preform manufacturing apparatus 100 shown in FIG. 4 is so constituted as to be suited for molding of a preform formed of a very small amount of material.

First, the constitution of the compression molding preform manufacturing apparatus 100 in the embodiment will be described.

On an apparatus frame 125, there are arranged a piston up-down mechanism 103 and a resin ejection mechanism 105 which ejects a fixed amount of resin in the up-direction. The resin injection mechanism 105 is arranged on the piston up-down mechanism 103, into which a piston is inserted vertically. A cylinder 110 of the resin ejection mechanism 105 has a through-hole 110a extending from a lower end 110b to an upper end 110c in a up-down direction (in a vertical direction parallel to a direction of A1 in the figure), and this through-hole 110a forms an elongated inner space. The transversely sectional shape of this through-hole (inner space) 110a is circular, and the through-hole 110a is formed so that the diameter and the sectional area of its transverse section become uniform throughout the entirety of the through-hole 110a. The transversely sectional diameter of the through-hole 110a is desirably equal to or smaller than 110 mm. Actually, it is good that its diameter is about 0.5 mm to 5 mm. In case that the transversely sectional diameter of the through-hole 110a is smaller, more accurate measurement can be performed. However, in case that the diameter is too small, since the ejection capacity by one shot decreases, the extra measuring time is required. Further, in case that the sectional area of the through-hole 110 is too small, the cylinder becomes long thereby not only to make processing of the cylinder difficult but also to cause resin pressure in the ejection time that is too high, so that a problem of buckling of the piston or a problem that it takes time to lower the resin pressure in the ejection time is produced.

Into the through-hole 110a of the cylinder 110, a part of the piston 111 is inserted from the lower end 110b. The piston 111 is formed in the elongated shape having a circular section similar to the inner shape of the through-hole 110a. The diameter of transverse section and the sectional area of the cylinder 110 are the same as the diameter of the piston 111. The piston 111 can slide in the through-hole 110a of the cylinder 110 in the up-down direction. The stroke of the piston 111 requires 1 mm or more from viewpoints that the shape accuracy of a resin product is 0.2 to 0.5%, and preferably about ±0.1 and the positional accuracy of the piston becomes about 1 μm considering accuracy of a servo motor.

The base end side of the piston 111 is fixed to a support plate 116 of the piston up-down mechanism 103, and the up-down movement of the support plate 116 can slide the piston 111 in the cylinder 110. The up-down mechanism 103 includes guides 117, 118 extending along the up-down direction (direction of the arrow A1), and guide holes into which these guides 117, 118 fitted are formed in the support plate 116. The support plate 116 moves up and down in a state where the guides 117, 118 are inserted into these guide holes, thereby to realize the up-down movement of the piston 111. Further, between the support plate 116 and the guide 117, 118, a ball bearing or the like is set in order to prevent inclination or unsteadiness.

Further, the piston up-down mechanism 103 has on the apparatus frame 125 a linear actuator for driving the support plate 116 and the piston 111 in the direction of the arrow A1. Specifically, the piston up-down mechanism 103 has an electric motor 119 installed securely on the apparatus frame 125 as a drive source, and a not-shown gear coupled to a drive shaft of the electric motor 119; and a ball screw 120 fixed to the support plate 116 is screwed to the gear. Accordingly, when the electric motor 119 is driven, the gear coupled to the electric motor 119 moves rotationally, whereby the ball screw 120 moves and the support plate 116 coupled to the ball screw 120 also moves up and down in the direction of the arrow A1. Further, as the electric motor 119, a servo motor or a stepping motor is used.

In order to detect positional information on movement in the stroke direction (direction of the arrow A1 of the support plate 116) of the piston 111, a displacement sensor 121 is provided near the support plate 116. The displacement sensor 121 detects the relative positional relation between the support plate 116 and the upper plate in the figure of the apparatus frame 125.

On the other hand, to a part of the peripheral surface of the cylinder 110, a plasticizing mechanism 112 as a resin material filling means is coupled. The plasticizing mechanism 112, while stirring resin material that is raw material of a product by a screw 112a, extrudes the resin material forward of ejection, generates liquid resin 130 which is melted by heating and frictional heat between the resins thereby to have flowability, and ejects the resin into the through-hole 110a of the cylinder 110. The ejection of the resin into the through-hole 110a is performed through a flowing path 112b for communicating the inner space of the plasticizing mechanism 112 and the through-hole 110a of the cylinder 110. Midway of the flowing path 112b, there is provided a check valve 126 for preventing reverse flow of the resin 130. Further, the screw 112a is driven by a plasticizing mechanism driving part 123.

Inside the cylinder 110, a heater 128 is embedded. This heater 128 heats the resin 130 poured into the through-hole 110a of the cylinder 110, whereby the temperature of the resin 130 is kept at the temperature equal to or higher than the glass transition point temperature. Further, at the periphery of the cylinder 110, an insulating material 107 is provided in an appropriate placement position. Further, also near the cylinder 110 of the apparatus frame 125, a heater, which is not shown, is provided, and the heater is constituted so that its side apart from the cylinder 110 of the heater is cooled by cooling water.

Between the junction of the through-hole 110a of the cylinder 110 and the flowing path 112b of the plasticizing mechanism 112, and an upper end portion 110c of the cylinder 110, and near an ejection port 115, an opening portion communicating with the through-hole 110a is formed, and a pressure sensor 113 is installed at this opening portion. The pressure sensor 113 detects the pressure applied to the resin 130 near the ejection port 115.

Further, around the ejection port 115, a cutter 114 is installed as a resin material cutting means which cuts the ejected resin. In the constitutional example shown in FIG. 4, the cutter 114 consists of a pair of blades 114a, 114b arranged on the right and left of the ejection port 115. These blades 114a, 114b are driven by a cutter drive part 122. When the blades 114a, 114b are driven by the cutter drive part 122, they are driven in a direction where they approach each other and in a direction where they are spaced apart from each other. The blades 114a, 114b reciprocate, whereby the resin 130 ejected from the ejection port 115 is cut. In the constitutional example shown in FIG. 4, though the cutter 114 is installed on a plate 127, it may be arranged in any position as long as it can cut the resin after ejection. Further, the cutter 114 is previously heated at a temperature (about Tg+50° C.) which is a little higher than the glass transition point temperature Tg of the resin material. This is because: in case that the temperature of the cutter is the normal temperature, the resin hardens from the blade portion and the resin material scatters in the cutting time; and in case that the temperature of the cutter is too high, the resin material sticks to the blade of the cutter 114.

A control part 124 controls the operation of each part in the apparatus shown in FIG. 4. Namely, to the control part 124, at least the pressure sensor 113, the cutter drive part 122, the plasticizing mechanism drive part 123, the displacement sensor 121, and the electric motor 119 are connected. The control part 124 may be constituted by a dedicated control circuit including a microprocessor or the like, or constituted by means of a versatile programmable controller or a personal computer.

Next, the actual operation of the compression molding preform manufacturing apparatus 100 will be described below.

The resin 130 put in the fluidized state by heating is extruded from the inner space of the plasticizing mechanism 112, and poured through the flowing path 112b into the through-hole 110a in the cylinder 110. Simultaneously, in order to pour the resin material 130 of the necessary volume, the electric motor 119 is driven while the positional information detected by the displacement sensor 121 is being referred to, and the piston 111 is let go down by the predetermined distance by which the capacity in the through-hole 110a is increased. By this operation, in a vacant area in which the piston 111 does not exit, of the through-hole 110a of the cylinder 110, the resin material 130 in the fluidized state is filled. Further, when this resin material is poured, it is preferable that the ejection port 115 is closed by the cutter 114.

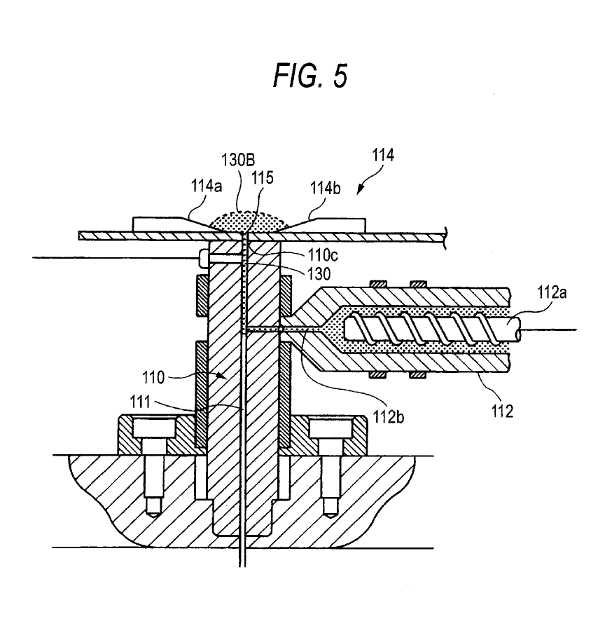

FIG. 5 is a partially enlarged sectional view of the vicinity of the piston and the ejection port.

The control part 124, when the predetermined amount of resin material 130 is filled into the through-hole 110a, drives the electric motor 119 and lets the piston 111 go up again. Hereby, as shown in FIG. 5, the resin material 130 poured into the inner space 110a in the cylinder 110 is pushed upward by the piston 111, and is gradually ejected from the ejection port 115.

The resin material 130 to be ejected from the ejection port 115 is previously heated inside the cylinder 110 by the heater 128 that is the heating means at the temperature equal to or higher than the glass transition point temperature.

By stopping the drive of the electric motor 119, the movement of the piston 111 is stopped. The resin material 130 ejected from the ejection port 115 accumulates above the ejection port 115, and a resin material 130B deposited as shown in FIG. 5 is formed.

When the piston 111 stops its movement by the predetermined stroke, the pressure applied to the resin material 130 is gradually released, and the pressure to be detected also lowers with the passage of time. Stable timing by lowering of the pressure is taken as a threshold. Under this threshold pressure, the cutter 114 is driven and the deposited resin material 130B is cut. The pressure sensor 113 detects repeatedly the pressure applied to the resin material 130, and compares the detected pressure value with the previously set threshold (nearly ordinary pressure). When it is recognized that the detected pressure has been reduced to a predetermined value, the resin material 130 is cut by the drive of the cutter 114 by the cutter drive part 22, and the resin material 130B deposited above the ejection port 115 is cut off from the resin material 130 inside the cylinder 110. The cut-off resin material 130B is utilized as a compression molding preform 15. It is to be hoped to add descriptions that the piston does not go up of the resin filling part, and the resin is filled up to the ejection port before start of measurement by the piston.

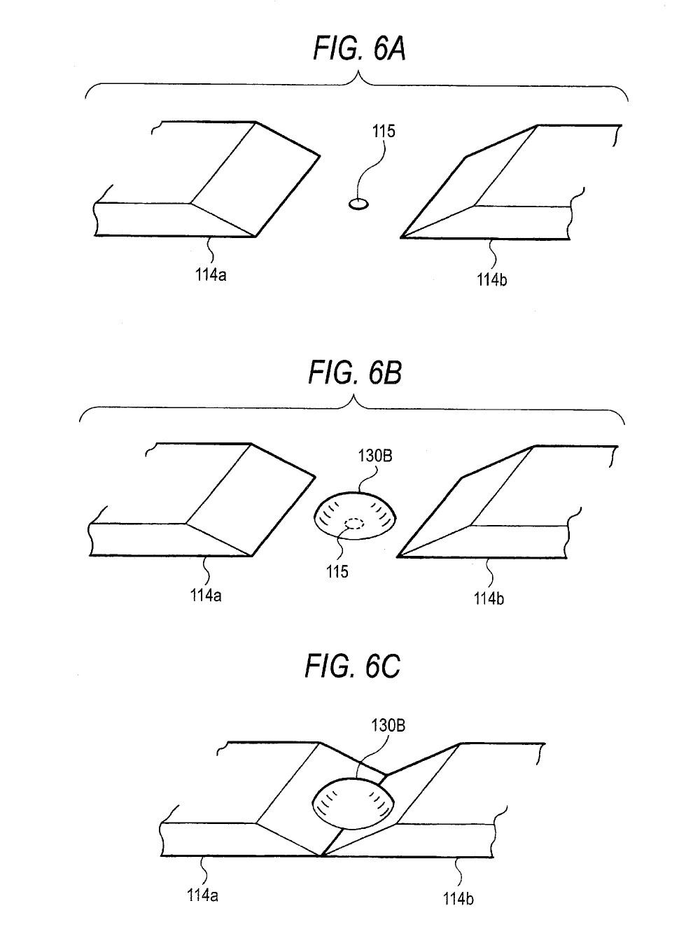

Next, the concrete example of the operation of the cutter in the cutting time of the resin material 130B will be described with reference to FIG. 6.

Namely, before the resin material 130 is ejected from the ejection port 115, the resin material 130 does not exist near the ejection port 115 as shown in FIG. 6A. As shown in FIG. 6B, by ejection of the resin material 130, resin material 130B is generated, which is accumulated in the position of the ejection port 115 and around the ejection port 115. When the cutter 114 is driven, the resin material 130B is in a lump state, in which the resin material 130B is kept at the temperature equal to or higher than the glass transition point temperature Tg. Next, both of the blades 114a and 114b move respectively in the horizontal direction from the left and right of the ejection port 115 to approach the ejection port 115, and get in the lower side of the resin material 130B to come into contact with each other as shown in FIG. 6C. Hereby, the resin material 130B is cut.

In the constitutional example shown in FIG. 6, though the cutter 114 is installed on the plate near the ejection port 115, it may be arranged in any position as long as it can cut the ejected resin. Further, the type of the cutter may be any type, for example, a cutter with three or more blades, or a cutter using a laser.

The preform measured one by one and prepared by the above-described lens preform forming mechanism in each embodiment is held by the handling mechanism 40 shown in FIG. 1, carried to the next step, the compression molding step 30 while keeping the temperature equal to or higher than the glass transition point temperature, and molded, through the state of the constant temperature equal to or lower than the glass transition point temperature, into a product.

As the lens preform providing means other than the above means, there is also the constitution in which a lens preform is blanked from a sheet-shaped resin material heated at the temperature equal to or higher than the glass transition point temperature and fed out from an extruder (not shown), and the lens preform keeping this temperature equal to or higher than the glass transition point temperature is formed into a product lens by a mold in a compression molding step which has the temperature equal to or lower than the glass transition point temperature.

The invention is not limited to the above mentioned embodiments, but modifications and improvements can be appropriately made.

The present application claims foreign priority based on Japanese Patent Application (JP 2007-072253) filed Mar. 20, 2007, the contents of which is incorporated herein by reference.

1. A plastic lens molding method comprising:
preparing a lens preform having the temperature equal to or higher than a glass transition point temperature; and
molding a lens by compressing the lens preform having the temperature equal to or higher than the glass transition point temperature, the compressing of the lens preform being performed by a mold providing a finished lens dimension at a constant temperature equal to or lower than the glass transition point temperature.

2. The plastic lens molding method as claimed in claim 1,
wherein
the preparing of the lens preform prepares a lens preform having the same weight as the weight of the lens.

3. The plastic lens molding method as claimed in claim 2,
wherein
the molding of the lens comprises performing an injection molding of the lens preform.

4. The plastic lens molding method as claimed in claim 3,
wherein
the molding of the lens comprises:
taking out the lens preform from an injection-molding machine at the temperature equal to or higher than the glass transition point temperature; and
immediately putting the lens preform, which is taken out from the injection-molding machine, in a compression mold.

5. The plastic lens molding method as claimed in claim 2,
wherein
the preparing of the lens preform comprises:
extruding a constant volume of melting plastic; and
cutting the extruded melting plastic.

6. The plastic lens molding method as claimed in claim 1,
wherein
the preparing of the lens preform comprises punching out the lens preform from a molded item having a sheet-shaped.
